(19) United States
(12) Patent Application Publication
(10) Pub. No.: US 2018/0239342 A1
(43) Pub. Date: Aug. 23, 2018

(54) METHOD AND APPARATUS FOR REGISTERING VIRTUAL EQUIPMENT FOR VIRTUAL PRODUCTION SYSTEM

(71) Applicant: ELECTRONICS AND TELECOMMUNICATIONS RESEARCH INSTITUTE, Daejeon (KR)

(72) Inventors: Young Ae JEON, Sejong-si (KR); Ho Jin PARK, Daejeon (KR); Hyun KIM, Daejeon (KR); Hyun Jong KIM, Cheongju-si (KR); Ji Yeon SON, Daejeon (KR); Yong Kwi LEE, Daejeon (KR); Hark Jin LEE, Daejeon (KR)

(21) Appl. No.: 15/899,549

(22) Filed: Feb. 20, 2018

(30) Foreign Application Priority Data
Feb. 22, 2017 (KR) 10-2017-0023592
Feb. 1, 2018 (KR) 10-2018-0012714

(51) Int. Cl. G05B 19/418; G06F 17/50; G06F 17/30

(52) U.S. Cl. CPC G05B 19/41885; G06F 2217/12; G06F 17/30283; G06F 17/5009

(57) ABSTRACT

A method of registering virtual equipment for a virtual production system includes generating a production system model and a production process model of a virtual factory on the basis of a structure database (DB), a production DB, and an operation DB, extracting a plurality of equipment behavior catalogs (EBCs) regarding a plurality of pieces of virtual equipment used in the virtual factory from an EBC repository on the basis of the production system model, generating and simulating a plurality of equipment processing models on the basis of the plurality of EBCs and the production process model, and generating an EBC set on the basis of the plurality of EBCs when a result of the simulation satisfies a predetermined criterion.

### CROSS-REFERENCE TO RELATED APPLICATIONS

This application claims priority to Korean Patent Applications No. 10-2017-0023592, filed Feb. 22, 2017, and No. 10-2018-0012714, filed Feb. 1, 2018, in the Korean Intellectual Property Office (KIPO) the entire contents of which are hereby incorporated by reference.

### BACKGROUND

### 1. Field of the Invention

Example embodiments of the present invention relate in general to a method and apparatus for registering virtual equipment for a virtual production system, and more specifically, to a method and apparatus for registering virtual equipment for a simulation of a virtual production system corresponding to a physical production system.

### 2. Description of Related Art

Since a catalog of equipment used in a simulation of an existing virtual production system contains only the property information of the equipment, there are limitations in accurately predicting productivity and efficiency of a smart virtual factory constructed with a virtual production system.

In order to overcome such drawbacks and accurately predict the productivity and efficiency of the smart virtual factory, not only the properties of equipment but also the behavior of the equipment, such as operation conditions of the equipment, state transition, and operation results, should be applied to the simulation of the virtual production system. Accordingly, there is a need for an equipment behavior catalog (EBC) that includes the behavior of equipment.

In addition, in order to perform a specific process in a smart virtual factory, one piece of equipment may be used, but occasionally a plurality of pieces of equipment may be used together. Conventionally, since the catalog is stored for each piece of equipment, when there are many cases in which the plurality of pieces of equipment are used together, it inconveniences a user.

Therefore, the present invention suggests a method of registering virtual equipment, which can accurately predict productivity and efficiency using an EBC and improve a user's inconvenience caused by the equipment-specific catalog when one or more pieces of equipment are required for a specific process in a virtual production system.

### SUMMARY

Embodiments of the present disclosure provide a method for registering virtual equipment for virtual production system.

Embodiments of the present disclosure also provide an apparatus for registering virtual equipment for virtual production system.

According to embodiments of the present disclosure, a method for registering virtual equipment comprising: generating a production system model and a production process model of a virtual factory on the basis of a structure database (DB), a production DB, and an operation DB, extracting a plurality of equipment behavior catalogs (EBCs) regarding a plurality of pieces of virtual equipment used in the virtual factory from an EBC repository on the basis of the production system model, generating and simulating a plurality of equipment processing models on the basis of the plurality of EBCs and the production process model, and generating an EBC set on the basis of the plurality of EBCs when a result of the simulation satisfies a predetermined criterion.

Wherein the EBC includes at least one of information about properties of equipment, information about operation conditions of the equipment, information about state transition of the equipment, information about an operation result of the equipment, information about upper equipment of the equipment, and information about lower equipment of the equipment.

Wherein the generating of the production system model and the production process model of the virtual factory on the basis of the structure DB, the production DB, and the operation DB includes generating the production system model using the structure DB and generating the production process model using the production DB and the operation DB according to a user's request.

Wherein the generating and simulating of the plurality of equipment processing models on the basis of the plurality of EBCs and the production process model includes generating a plurality of unit processes used in the virtual factory on the basis of the production process model.

Wherein the generating and simulating of the plurality of equipment processing models on the basis of the plurality of EBCs and the production process model further includes generating a plurality of equipment instance models regarding the plurality of pieces of virtual equipment on the basis of the plurality of EBCs.

Wherein the generating and simulating of the plurality of equipment processing models on the basis of the plurality of EBCs and the production process model further includes generating the plurality of equipment processing models to perform a simulation by mapping the plurality of unit processes and the plurality of equipment instance models regarding the plurality of pieces of virtual equipment.

The method further comprises registering the generated EBC set in the EBC repository.

The method further comprises storing information about generation of the EBC set in the structure DB, the production DB, and the operation DB, and inputting the information about generation of the EBC set to the production system model and the production process model.

The method further comprises extracting the EBC set regarding a set of virtual equipment used in the virtual factory from the EBC repository when an additional simulation for the virtual factory is requested by a user.

The method further comprises generating a sub-process corresponding to the EBC set on the basis of the production process model, generating an equipment instance model for the set of virtual equipment on the basis of the EBC set, and generating the plurality of equipment processing models to perform a simulation by mapping the sub-process and the equipment instance model for the set of virtual equipment.

According to embodiments of the present disclosure, an apparatus for registering virtual equipment comprising: a processor, and a memory in which at least one command to be executed by the processor is stored, wherein the at least one command is executed to: generate a production system model and a production process model of a virtual factory on the basis of a structure DB, a production DB, and an operation DB, extract a plurality of equipment behavior catalogs (EBCs) regarding a plurality of pieces of virtual equipment used in the virtual factory from an EBC repository on the basis of the production system model, generate and simulate a plurality of equipment processing models on the basis of the plurality of EBCs and the production process model, and generate an EBC set on the basis of the plurality of EBCs when a result of the simulation satisfies a predetermined criterion.

Wherein the EBC includes at least one of information about properties of equipment, information about operation conditions of the equipment, information about state transition of the equipment, information about an operation result of the equipment, information about upper equipment of the equipment, and information about lower equipment of the equipment.

Wherein the at least one command is executed to generate the production system model using the structure DB and generate the production process model using the production DB and the operation DB according to a user's request.

Wherein the at least one command is executed to generate a plurality of unit processes used in the virtual factory on the basis of the production process model.

Wherein the at least one command is executed to generate a plurality of equipment instance models regarding the plurality of pieces of virtual equipment on the basis of the plurality of EBCs.

Wherein the at least one command is executed to generate the plurality of equipment processing models to perform a simulation by mapping the plurality of unit processes and the plurality of equipment instance models regarding the plurality of pieces of virtual equipment.

Wherein the at least one command is executed to register the generated EBC set in the EB repository.

Wherein the at least one command is executed to store information about generation of the EBC set in the structure DB, the production DB, and the operation DB and input the information about generation of the EBC set to the production system model and the production process model.

Wherein the at least one command is executed to extract the EBC set regarding a set of virtual equipment used in the virtual factory from the EBC repository when an additional simulation for the virtual factory is requested by a user.

Wherein the at least one command is executed to: generate a sub-process corresponding to the EBC set on the basis of the production process model, generate an equipment instance model for the set of virtual equipment on the basis of the EBC set, and generate the plurality of equipment processing models to perform a simulation by mapping the sub-process and the equipment instance model for the set of virtual equipment.

According to the present invention, a virtual production system capable of accurately predicting productivity and efficiency is provided, which can be utilized in optimization of an actual production factory.

According to the present invention, a plurality of relevant EBCs that can be repeatedly used are managed as one set, thereby providing convenience to the user.

### BRIEF DESCRIPTION OF DRAWINGS

Example embodiments of the present invention will become more apparent by describing in detail example embodiments of the present invention with reference to the accompanying drawings, in which:

FIG. 1 is a diagram illustrating a configuration of an equipment behavior catalog (EBC) according to one example embodiment of the present invention;

FIG. 2 is a conceptual diagram for describing a method of performing a specific process using a registered EBC according to one example embodiment of the present invention;

FIG. 3 is a block diagram of a virtual equipment registering apparatus according to one example embodiment of the present invention;

FIG. 4 is a flowchart illustrating a method of registering virtual equipment according to one example embodiment of the present invention;

FIG. 5 is a conceptual diagram for describing a method of generating an EBC set corresponding to a sub-process on the basis of an EBC corresponding to a unit process according to one example embodiment of the present invention;

FIG. 6 is a diagram illustrating an EBC set and a sub-process corresponding to the EBC set according to one example embodiment of the present invention; and

FIG. 7 is a conceptual diagram for describing a method of performing a specific process using a registered EBC set according to one example embodiment of the present invention.

### DESCRIPTION OF EXAMPLE EMBODIMENTS

Example embodiments of the present invention are disclosed herein. However, specific structural and functional details disclosed herein are merely representative for purposes of describing the example embodiments of the present invention, and the example embodiments of the present invention may be embodied in many alternate forms and should not be construed as limited to the example embodiments of the present invention set forth herein.

Accordingly, while the present invention is susceptible to various modifications and alternative forms, specific embodiments thereof are shown by way of example in the drawings and will herein be described in detail. It should be understood, however, that there is no intent to limit the present invention to the particular forms disclosed, but on the contrary, the present invention is to cover all modifications, equivalents, and alternatives falling within the spirit and scope of the present invention. Like numbers refer to like elements throughout the description of the figures.

It will be understood that, although the terms first, second, etc. may be used herein to describe various elements, the elements should not be limited by the terms. The terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

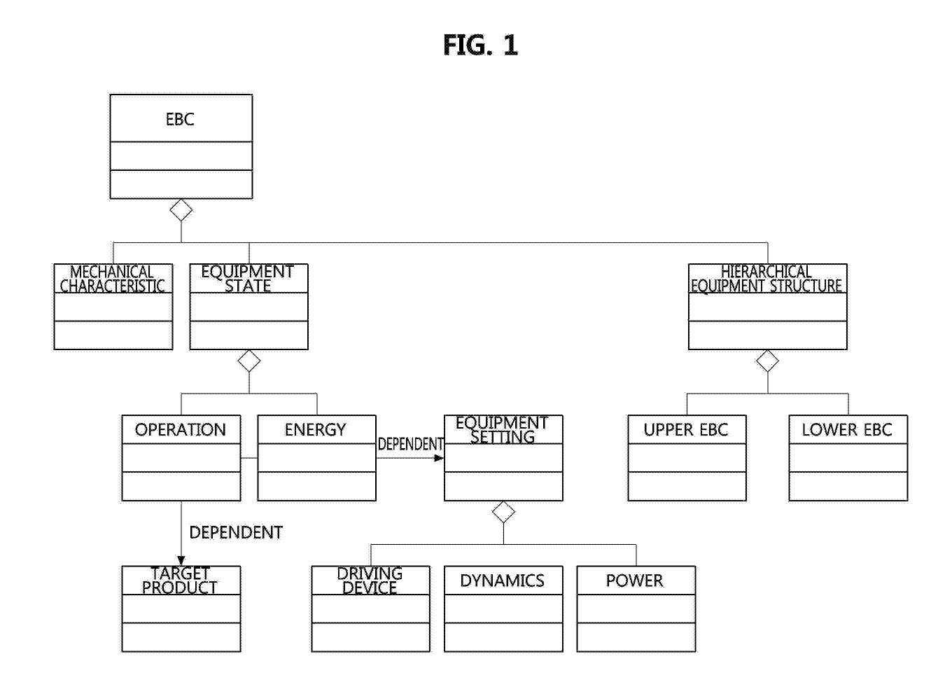

FIG. 1 is a diagram illustrating a configuration of an equipment behavior catalog (EBC) according to one example embodiment of the present invention.

The EBC according to one example embodiment of the present invention may include information about equipment operation conditions, equipment state transition, and equipment operation results, in addition to equipment properties, in order to overcome limitations of an existing equipment catalog.

More specifically, referring to FIG. 1, the EBC may include information on mechanical characteristics of corresponding equipment, an equipment state, and a hierarchical equipment structure, wherein the equipment state may include information about operations and consumption energy of the equipment and the hierarchical equipment structure may include information about an upper EBC and a lower EBC.

Here, the information about the equipment operations may be dependent on a target product of the corresponding equipment, and the information about the consumption energy of the equipment may be dependent on settings of the equipment. In addition, the settings of the equipment may include information on driving devices, dynamics, and power. The hierarchical equipment structure may include information about a case in which one or more pieces of equipment perform a specific function together, the upper EBC information may include information about corresponding equipment which corresponds to accessary equipment, and the lower EBC information may include information about corresponding equipment which is main equipment capable of including accessary equipment. However, the information to be included in the EBC is not limited thereto, and may include a variety of information about the equipment.

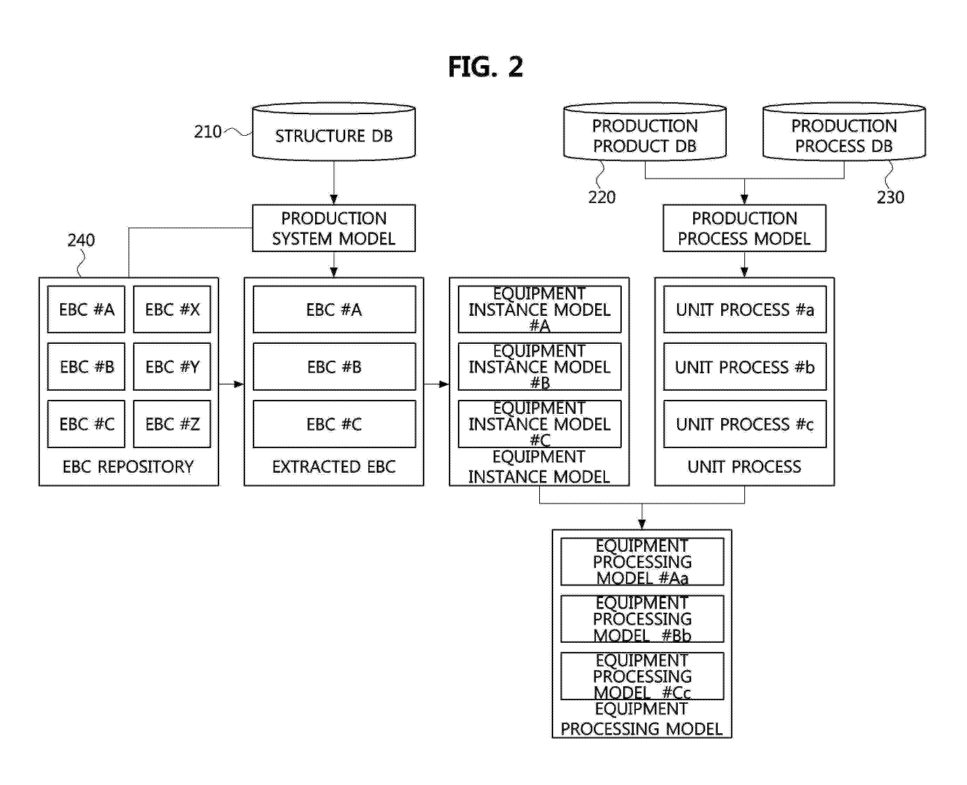

FIG. 2 is a conceptual diagram for describing a method of performing a specific process using a registered EBC according to one example embodiment of the present invention.

Referring to FIG. 2, the method of performing a specific process using an EBC in accordance with to one example embodiment of the present invention may generate a production system model that is suitable for a virtual factory to be simulated by a user, on the basis of a structure database (DB) 210, and generate a production process model based on a production product DB 220 and a production process DB 230.

In this case, the structure DB 210 may include virtual factory information about virtual equipment which may be used in a virtual factory, and the production system model may be generated by extracting virtual factory information required for a virtual factory requested by a user on the basis of virtual equipment information stored in the structure DB 210. In addition, the production product DB 220 may include information about products which may be produced in the virtual factory, the production process DB 230 may include information about a process that may be implemented in the virtual factory, and the production process model may be generated by extracting production product information required in the virtual factory requested by the user and production process information on the basis of product information stored in the production product DB 220 and process information stored in the production process DB 230.

The method of performing a specific process using an EBC according to one example embodiment of the present invention may extract an EBC of equipment, which will be used in the virtual factory, from an EBC repository 240 on the basis of the production system model. In this case, the EBC repository 240 may include at least one EBC regarding virtual equipment. In addition, the method of performing a specific process using an EBC may generate an equipment instance model on the basis of the extracted EBC. The equipment instance model may refer to a virtual equipment model generated on the basis of an EBC to be mapped to a process.

The method of performing a specific process using an EBC according to one example embodiment of the present invention may generate a unit process, which will be used in the virtual factory, on the basis of the production process model and the generated unit process may be mapped to the equipment instance model to generate an equipment processing model.

In other words, in the method of performing a specific process using an EBC according to one example embodiment of the present invention, when a specific virtual factory is set by the user, equipment and processes to be used in the specific virtual factory are extracted and the extracted equipment and processes are mapped to each other, so that the virtual factory can be simulated.

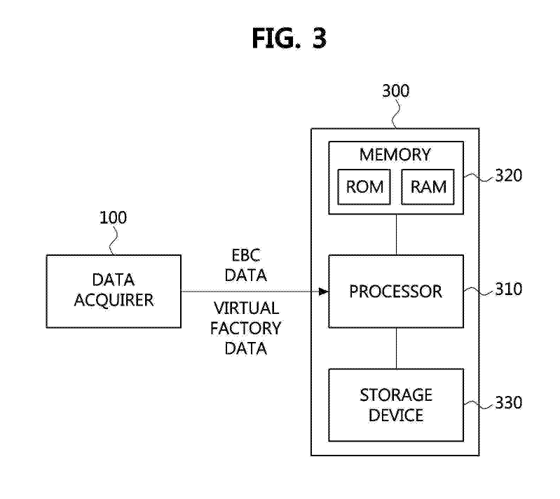

FIG. 3 is a block diagram of a virtual equipment registering apparatus according to one example embodiment of the present invention.

Referring to FIG. 3, a virtual equipment registering apparatus 300 according to one example embodiment of the present invention may include at least one processor 310, a memory 320, and a storage device 330.

The processor 310 may execute program commands stored in the memory 320 and/or the storage device 330. The processor 310 may refer to a central processing unit (CPU), a graphics processing unit (GPU), or a dedicated processor in which methods according to the present invention are performed. The memory 320 and the storage device 330 may be configured with a volatile storage medium and/or a non-volatile storage medium. For example, the memory 320 may be configured with a read only memory (ROM) and/or a random access memory (RAM).

At least one command to be executed through the processor 310 may be stored in the memory 320. The at least one command may include a command for generating a production system model and a production process model of a virtual factory on the basis of a structure DB, a production DB, and an operation DB, a command for extracting a plurality of EBCs for a plurality of pieces of virtual equipment used in the virtual factory from an EBC repository on the basis of the production system model, a command for simulation by generating a plurality of equipment processing models on the basis of a plurality of EBCs and the production process model, and a command for generating an EBC set on the basis of the plurality of EBCs when a simulation result satisfies a predetermined criterion.

In addition, the at least command may further include at least one of a command for acquiring at least one of EBC data and virtual factory data, a command for registering the generated EBC set in the EBC repository, and a command for extracting an EBC set regarding a set of virtual equipment used in the virtual factory from the EBC repository when an additional simulation for the virtual factory is requested by the user.

The processor 310 may acquire EBC data and virtual factory data from a data acquirer 100 according to the command stored in the memory 320. In other words, the processor 310 may acquire new EBC data and store the new EBC data in the EBC repository. When the processor 310 acquires the new EBC data, the processor 310 may input information about the acquisition of the new EBC data into the structure DB 210, the production product DB 220, and the production process DB 230. In this case, the structure DB 210, the production product DB 220, and the production process DB 230 may be stored in the storage device 330. In addition, the processor 310 may acquire virtual factory data for simulation set by the user. The virtual factory data may refer to selection information selected by the user on the basis of data stored in each of DBs, or may refer to data about sizes, processes, equipment, purposes, and production products of the virtual factory set by the user, but is not limited thereto.

The processor 310 may generate a production system model and a production process model of the virtual factory on the basis of the structure DB, the production DB, and the operation DB according to the command stored in the memory 320. The production system model may be generated using the structure DB 210 on the basis of the virtual factory data set by the user, and the production process model may be generated using the production product DB 220 and the production process DB 230 on the basis of the virtual factory data set by the user.

The processor 310 may extract a plurality of EBCs regarding a plurality of pieces of virtual equipment used in the virtual factory from the EBC repository on the basis of the production system model according to the command stored in the memory 320. Here, the plurality of EBCs may be extracted from the EBC repository according to the production system model on the basis of the virtual factory data set by the user, and when an EBC set, which will be described below, is stored in the EBC repository, the EBC set may be extracted, rather than the plurality of EBCs.

The processor 310 may generate and simulate a plurality of equipment processing models on the basis of the plurality of EBCs and the production process model according to the command stored in the memory 320. More specifically, the processor 310 may generate a plurality of unit processes used in the virtual factory on the basis of the production process model according to the command stored in the memory 320, generate a plurality of equipment instance models regarding a plurality of pieces of virtual equipment on the basis of the plurality of EBCs, and generate a plurality of equipment processing models to perform a simulation by mapping the plurality of unit processes and the plurality of equipment instance models regarding the plurality of pieces of virtual equipment.

In this case, the unit process may be a virtual unit process used in a virtual factory generated according to the production process model based on the virtual factory data set by the user. When the processor 310 does not extract the plurality of EBCs and extracts an EBC set, a virtual sub-process, which may not be mapped to the plurality of unit processes and may be mapped to the EBC set, may be generated on the basis of the production process model.

The equipment instance model may refer to a model that generates virtual equipment on the basis of information contained in the EBC, and when the processor 310 does not extracts the plurality of EBCs and extracts the EBC set, the equipment instance model may refer to a model that generates a virtual equipment set on the basis of information contained in the EBC set.

The equipment processing model may refer to a model that performs a simulation by mapping the virtual unit process and the virtual equipment, and when the processor 310 does not extract the plurality of EBCs and extracts the EBC set, the equipment processing model may refer to a model to perform a simulation for each piece of equipment and each unit process by mapping the virtual sub-process and the virtual equipment set.

In other words, when the EBC set is extracted, the process may be performed in one set, such as the sub-process and the virtual equipment set, but the equipment processing models may be generated for each of the unit processes and each of the pieces of equipment. In this case, a typical simulation method may be used.

The processor 310 may generate an EBC set on the basis of the plurality of EBCs when the simulation result satisfies a predetermined criterion according to the command stored in the memory 320. The predetermined criterion may be a criterion for a performance of a specific virtual factory set or designed by the user. The performance of the virtual factory may include production speed, production output, safety, power consumption, and the like.

The EBC set may refer to a set of EBCs or a set of information about virtual equipment satisfying the criterion set by the user. Information about the EBC set may be recorded on the upper EBC information or the lower EBC information which is included in the hierarchical equipment structure information of the EBC. Therefore, when a simulation is performed again, a plurality of pieces of equipment satisfying the predetermined criterion may be immediately extracted, so that a re-simulation process can be effectively performed.

The processor 310 may register the EBC set generated according to the command stored in the memory 320 in the EBC repository. Here, the EBC set may be stored and managed in the EBC repository together with other EBCs and constituent EBCs of the EBC set, and information about the generation of the EBC set may be input into the structure DB 210, the production product DB 220, and the production process DB 230.

A method of simulating a virtual factory on the basis of an EBC according to one example embodiment of the present invention will be described with an example of a vehicle door trim assembly process.

First, the vehicle door trim assembly process may be performed using infrared detection sensor equipment, vision-based barcode recognition equipment, screw driver equipment, automated guided vehicle (AGV) equipment, and panel PC (PPC) equipment.

The infrared detection sensor equipment may refer to equipment that detects when an AGV enters a workbench in an idle state and transmits an AGV-in signal to the vision-based barcode recognition equipment, and the vision-based barcode recognition equipment may refer to equipment that acquires a barcode image through auto-zoom in, auto-focus, and/or auto-shooting when the AGV-in signal indicating the entering of the AGV is received from the infrared detection sensor equipment in an idle state, extracts a barcode from the acquired barcode image, performs preprocessing so as to allow the barcode to be more clearly recognized in the process of barcode extraction, and transmits a result of recognizing the barcode from the preprocessed barcode image to a barcode processing program of the PPC.

In addition, the screw driver equipment may refer to equipment that transmits the number of assembled screws to the PPC when an operator assembles a number of screws set by the PPC in an idle state to predetermined positions of a door trim. The AGV equipment may refer to equipment that enters an assembly process workbench when the equipment receives a start signal from a server in an idle state, and after the equipment enters the assembly process workbench, the equipment recognizes a tag on a bottom of the workbench and stops until the assembly process is completed. Then, when the screw assembly process is completed, the AGV equipment receives a start signal from the server and then exits the current workbench to enter the next process workbench. The PPC equipment may refer to equipment that has an Ethernet communication interface for communicating with the server to receive information necessary for the assembly process from the server or inform the server of an assembly process state.

The method of registering virtual equipment according to one example embodiment of the present invention may extract EBCs regarding the infrared detection sensor equipment, the vision-based barcode recognition equipment, the screw driver equipment, the AGV equipment, and the PPC equipment from the EBC repository, and generate equipment instance models on the basis of the EBCs of the equipment. In addition, the method may generate a virtual unit process in which the above-described equipment is used, and generate equipment processing models by mapping the virtual equipment and the virtual unit process according to the equipment instance models, thereby performing a simulation.

In other words, when the AGV enters the workbench, a simulation of transmitting an AGV-in signal may be performed using the equipment processing model of the infrared detection sensor equipment, and a simulation of acquiring a barcode image, extracting a barcode, preprocessing, and transmitting a recognition result to the PPC when the AGV-in signal is received may be performed using the equipment processing model of the vision-based barcode recognition equipment. Also, a simulation of transmitting the number of screws to the PPC when the operator assembles the screws to fixed positions may be performed using the equipment processing model of the screw driver equipment, and a simulation of entering the workbench, stopping until the assembly process is completed, and exiting the workbench upon receiving a start signal may be performed using the equipment processing model of the AGV equipment. In addition, a simulation of receiving information and informing the server of a state may be performed using the equipment processing model of the PPC equipment.

In addition, according to the method of registering virtual equipment according to one example embodiment of the present invention, when the simulation result satisfies a criterion set by the user, EBCs of the infrared detection sensor equipment, the vision-based barcode recognition equipment, the screw driver equipment, the AGV equipment, and the PPC equipment, which are pieces of equipment used for the simulation of the vehicle door trim assembly process, may be generated as one EBC set, and the generated EBC set may be registered in the EBC repository.

Accordingly, when the user performs a simulation again, it is possible to extract a vehicle door trim assembly EBC set, rather than extracting the individual EBCs of the infrared detection sensor equipment, the vision-based barcode recognition equipment, the screw driver equipment, the AGV equipment, and the PPC equipment, from the EBC repository, and perform a simulation using the EBC set.

That is, by using the equipment processing models of the respective equipment in a set of vehicle door trim assembly equipment, a simulation of transmitting an AGV-in signal when the AGV enters the workbench, a simulation of acquiring a barcode image, extracting a barcode, preprocessing, and transmitting a recognition result to the PPC when the AGV-in signal is received, a simulation of transmitting the number of screws to the PPC when the operator assembles the screws to fixed positions, a simulation of entering the workbench, stopping until the assembly process is completed, and exiting the workbench upon receiving a start signal, and a simulation of receiving related information and informing the server of the state may be performed together.

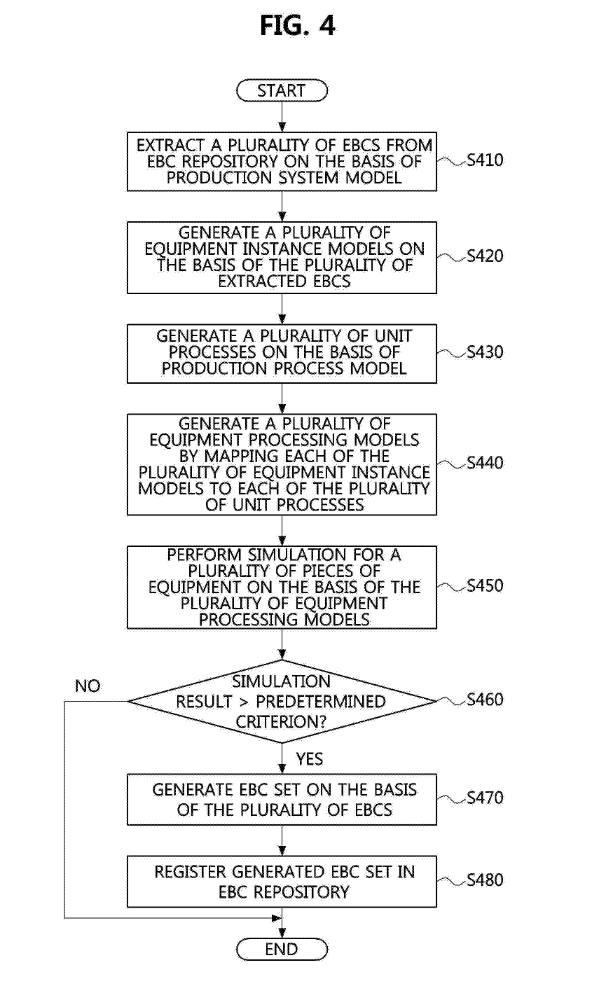

The above processes will be generalized and described in order with reference to FIG. 4.

FIG. 4 is a flowchart illustrating a method of registering virtual equipment according to one example embodiment of the present invention.

Referring to FIG. 4, in the method of registering virtual equipment according to one example embodiment of the present invention, a plurality of EBCs may be extracted from an EBC repository on the basis of a production system model (S410), and a plurality of equipment instance models may be generated on the basis of the plurality of extracted EBCs (S420). In this case, the production system model may be generated on the basis of virtual factory data set by a user, and the equipment instance model may refer to an EBC-based virtual equipment model which will be mapped to a process.

Then, a plurality of unit processes may be generated on the basis of a production process model (S430), and a plurality of equipment processing models may be generated by mapping each of the plurality of equipment instance models to each of the plurality of unit processes (S440). Here, the production process model may be generated on the basis of virtual factory data set by the user, and the equipment processing model may refer to a process to be performed in the virtual factory.

In addition, simulations for a plurality of pieces of equipment may be performed on the basis of the plurality of equipment processing models (S450), and when the simulation result is not higher than a criterion predetermined by the user, the process may be terminated.

However, when the simulation result is higher than the predetermined criterion, the plurality of EBCs used in the simulation may be considered as a set and then generated into an EBC set (S470), and the generated EBC set may be stored in the EBC repository (S480).

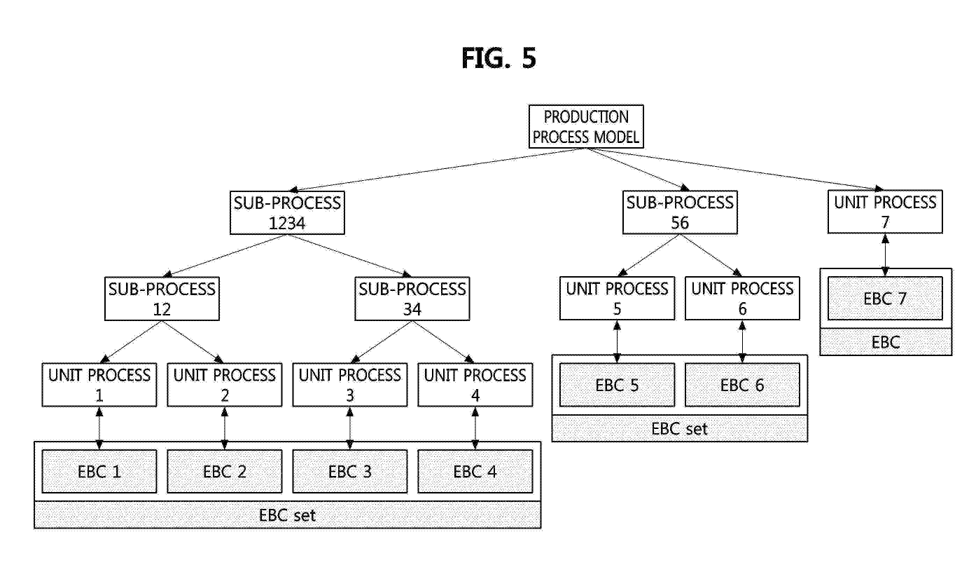

FIG. 5 is a conceptual diagram for describing a method of generating an EBC set corresponding to a sub-process on the basis of an EBC corresponding to a unit process according to one example embodiment of the present invention.

The method of registering virtual equipment according to one example embodiment of the present invention may generate a plurality of unit processes on the basis of the production process model, or map EBCs, which correspond to the unit processes, to the unit processes.

Referring to FIG. 5, a description will be provided under the assumption of a specific production process model. Processes included in the specific production process model may be divided into two sub-processes (sub-process 1234 and sub-process 56) and one unit process 7. The sub-process 1234 may be divided into sub-process 12 and sub-process 34, and the sub-process 56 may be divided into unit process 5 and unit process 6. In addition, the sub-process 12 may be divided into unit process 1 and unit process 2, and the sub-process 34 may be divided into unit process 3 and unit process 4. Thus, the specific production process model may generate seven unit processes, and each of the seven unit processes may correspond to one of EBCs 1 to 7.

Then, equipment instance models 1 to 7 may be generated on the basis of the EBCs 1 to 7 and may each be mapped to one of the seven unit processes to generate seven equipment processing models, and a simulation may be performed on the basis of the seven equipment processing models.

When the simulation results using the equipment processing models corresponding to the unit processes 1 to 4 are higher than a criterion set by a user, the EBCs 1 to 4 are generated as one EBC set, and information about generation of the EBC set corresponding to the sub-process 1234 may be transmitted and input to the structure DB 210, the production product DB 220, and the production process DB 230.

In addition, when the simulation results using the equipment processing models corresponding to the unit processes 5 and 6 are higher than the criterion set by the user, the EBCs 5 and 6 may be generated as one EBC set, and information about the generation of the EBC set corresponding to the sub-process 56 may be transmitted and input to the structure DB 210, the production product DB 220, and the production process DB 230.

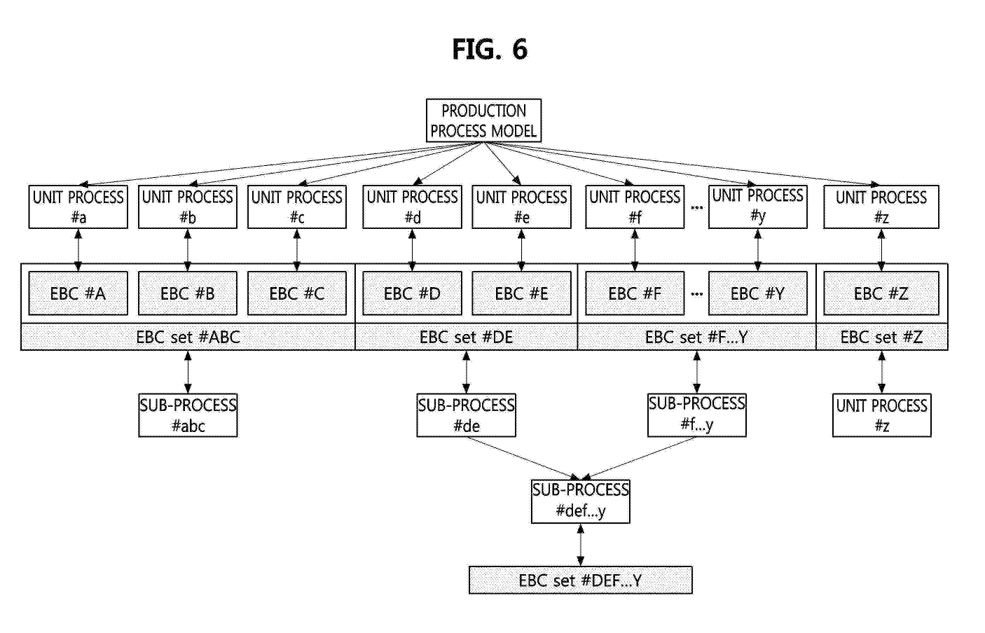

FIG. 6 is a diagram illustrating an EBC set and a sub-process corresponding to the EBC set according to one example embodiment of the present invention.

Referring to FIG. 6, EBC set #ABC including EBC #A, EBC #B, and EBC #C may correspond to sub-process #abc that includes unit process #a, unit process #b, and unit process #c which correspond to the EBC #A, the EBC #B, and the EBC #C, respectively. EBC set #DE including EBC #D and EBC #E may correspond to sub-process #de that includes unit process #d and unit process #e which correspond to the EBC #D and the EBC #E, respectively. In addition, EBC set #F . . . Y including EBC #F to EBC #Y may correspond to sub-process #f . . . y that includes unit process #f to unit process #y which correspond to the EBC #F to the EBC #Y, respectively, and EBC #Z may correspond to unit process #z.

In this case, sub-process #def . . . y may be generated on the basis of the sub-process #de and the sub-process #f . . . y, and the generated sub-process #def . . . y may correspond to EBC set #DEF . . . Y based on the EBC set #DE and the EBC set #F . . . Y.

In other words, when the EBC set #DEF . . . Y is extracted from the EBC repository on the basis of the production system model, the sub-process #def . . . y may be generated on the basis of the production process model and mapped with the EBC set #DEF . . . Y.

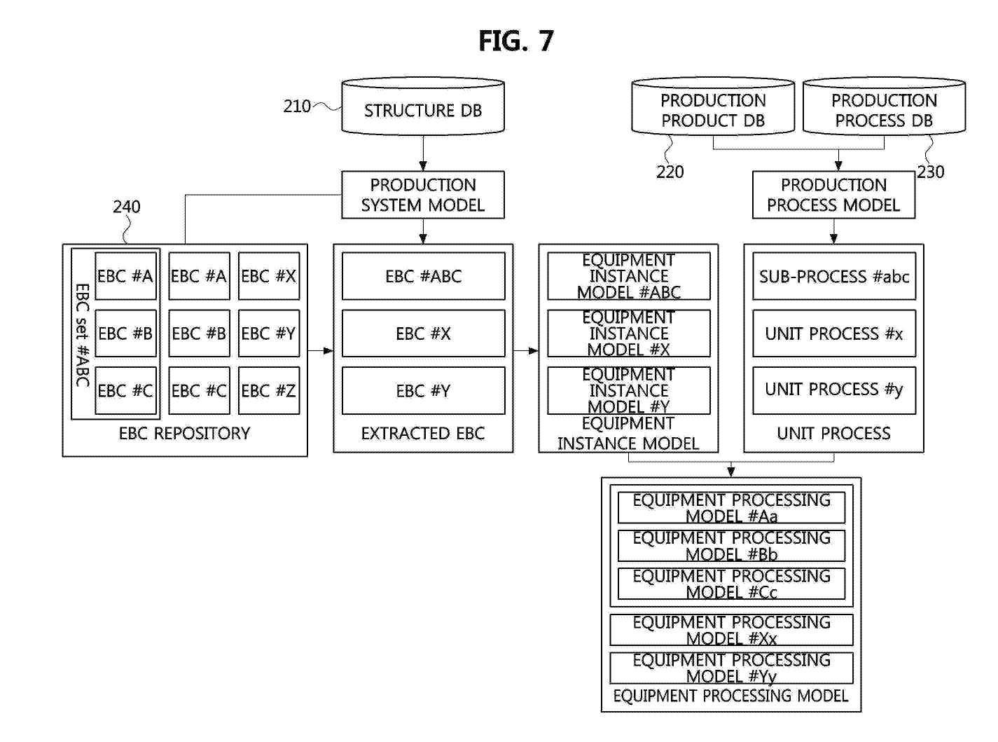

FIG. 7 is a conceptual diagram for describing a method of performing a specific process using a registered EBC set according to one example embodiment of the present invention.

Referring to FIG. 7, in the method of performing a specific process using an EBC set according to one example embodiment of the present invention, a production system model suitable for a virtual factory to be simulated by a user on the basis of the structure DB 210 may be generated, and a production process model may be generated on the basis of the production product DB 220 and the production process DB 230. In this case, the structure DB 210, the production product DB 220, and the production process DB 230 may be DBs to which information about generation of EBC set is input.

For convenience of description, it is assumed that the EBC set stored in the EBC repository is EBC set #ABC.

In the method of performing a specific process using an EBC set according to one example embodiment of the present invention, EBC set #ABC may be extracted from the EBC repository and equipment instance model #ABC may be generated on the basis of the extracted EBC set #ABC. In addition, according to the method of performing a specific process, sub-process #abc corresponding to the EBC set #ABC may be generated on the basis of a production process model, and the equipment instance model #ABC and the sub-process #abc may be mapped to each other to generate equipment processing model #Aa, equipment processing model #Bb, and equipment processing model #Cc.

That is, the equipment instance model and the sub-process may be generated for one equipment set, but the equipment processing model for a simulation may be generated for each piece of equipment and each unit process.

According to the present invention, a virtual production system capable of accurately predicting productivity and efficiency is provided, which can be utilized in optimization of an actual production factory.

According to the present invention, a plurality of relevant EBCs that can be repeatedly used are managed as one set, thereby providing convenience to the user.

While the example embodiments of the present invention and their advantages have been described in detail, it should be understood that various changes, substitutions and alterations may be made herein without departing from the scope of the present invention.

What is claimed is:

1. A method of registering virtual equipment, comprising:
generating a production system model and a production process model of a virtual factory on the basis of a structure database (DB), a production DB, and an operation DB;
extracting a plurality of equipment behavior catalogs (EBCs) regarding a plurality of pieces of virtual equipment used in the virtual factory from an EBC repository on the basis of the production system model;
generating and simulating a plurality of equipment processing models on the basis of the plurality of EBCs and the production process model; and
generating an EBC set on the basis of the plurality of EBCs when a result of the simulation satisfies a predetermined criterion.

2. The method of claim 1, wherein the EBC includes at least one of information about properties of equipment, information about operation conditions of the equipment, information about state transition of the equipment, information about an operation result of the equipment, information about upper equipment of the equipment, and information about lower equipment of the equipment.

3. The method of claim 1, wherein the generating of the production system model and the production process model of the virtual factory on the basis of the structure DB, the production DB, and the operation DB includes generating the production system model using the structure DB and generating the production process model using the production DB and the operation DB according to a user's request.

4. The method of claim 1, wherein the generating and simulating of the plurality of equipment processing models on the basis of the plurality of EBCs and the production process model includes generating a plurality of unit processes used in the virtual factory on the basis of the production process model.

5. The method of claim 4, wherein the generating and simulating of the plurality of equipment processing models on the basis of the plurality of EBCs and the production process model further includes generating a plurality of equipment instance models regarding the plurality of pieces of virtual equipment on the basis of the plurality of EBCs.

6. The method of claim 5, wherein the generating and simulating of the plurality of equipment processing models on the basis of the plurality of EBCs and the production process model further includes generating the plurality of equipment processing models to perform a simulation by mapping the plurality of unit processes and the plurality of equipment instance models regarding the plurality of pieces of virtual equipment.

7. The method of claim 1, further comprising registering the generated EBC set in the EBC repository.

8. The method of claim 7, further comprising:
storing information about generation of the EBC set in the structure DB, the production DB, and the operation DB; and
inputting the information about generation of the EBC set to the production system model and the production process model.

9. The method of claim 8, further comprising extracting the EBC set regarding a set of virtual equipment used in the virtual factory from the EBC repository when an additional simulation for the virtual factory is requested by a user.

10. The method of claim 9, further comprising:
generating a sub-process corresponding to the EBC set on the basis of the production process model;
generating an equipment instance model for the set of virtual equipment on the basis of the EBC set; and
generating the plurality of equipment processing models to perform a simulation by mapping the sub-process and the equipment instance model for the set of virtual equipment.

11. An apparatus for registering virtual equipment, comprising:
a processor; and
a memory in which at least one command to be executed by the processor is stored,
wherein the at least one command is executed to:
generate a production system model and a production process model of a virtual factory on the basis of a structure DB, a production DB, and an operation DB;
extract a plurality of equipment behavior catalogs (EBCs) regarding a plurality of pieces of virtual equipment used in the virtual factory from an EBC repository on the basis of the production system model;
generate and simulate a plurality of equipment processing models on the basis of the plurality of EBCs and the production process model; and
generate an EBC set on the basis of the plurality of EBCs when a result of the simulation satisfies a predetermined criterion.

12. The apparatus of claim 11, wherein the EBC includes at least one of information about properties of equipment, information about operation conditions of the equipment, information about state transition of the equipment, information about an operation result of the equipment, information about upper equipment of the equipment, and information about lower equipment of the equipment.

13. The apparatus of claim 11, wherein the at least one command is executed to generate the production system model using the structure DB and generate the production process model using the production DB and the operation DB according to a user's request.

14. The apparatus of claim 11, wherein the at least one command is executed to generate a plurality of unit processes used in the virtual factory on the basis of the production process model.

15. The apparatus of claim 14, wherein the at least one command is executed to generate a plurality of equipment instance models regarding the plurality of pieces of virtual equipment on the basis of the plurality of EBCs.

16. The apparatus of claim 15, wherein the at least one command is executed to generate the plurality of equipment processing models to perform a simulation by mapping the plurality of unit processes and the plurality of equipment instance models regarding the plurality of pieces of virtual equipment.

17. The apparatus of claim 11, wherein the at least one command is executed to register the generated EBC set in the EB repository.

18. The apparatus of claim 17, wherein the at least one command is executed to store information about generation of the EBC set in the structure DB, the production DB, and the operation DB and input the information about generation of the EBC set to the production system model and the production process model.

19. The apparatus of claim 18, wherein the at least one command is executed to extract the EBC set regarding a set of virtual equipment used in the virtual factory from the EBC repository when an additional simulation for the virtual factory is requested by a user.

20. The apparatus of claim 19, wherein the at least one command is executed to:
generate a sub-process corresponding to the EBC set on the basis of the production process model;
generate an equipment instance model for the set of virtual equipment on the basis of the EBC set; and
generate the plurality of equipment processing models to perform a simulation by mapping the sub-process and the equipment instance model for the set of virtual equipment.
